(19) United States
(12) Patent Application Publication
(10) Pub. No.: US 2024/0372363 A1
(43) Pub. Date: Nov. 7, 2024

(54) ELECTRICAL SWITCHING DEVICE

(71) Applicant: Murrelektronik GmbH, Oppenweiler (DE)

(72) Inventors: Rudolf Lang, Burgstetten (DE); Ingo Wolff, Oehringen (DE)

(21) Appl. No.: 18/656,447

(22) Filed: May 6, 2024

(30) Foreign Application Priority Data
May 4, 2023 (EP) 23171691.1

(51) Int. Cl. H02J 3/00

(52) U.S. Cl. CPC H02J 3/007

(57) ABSTRACT

An electrical switching device includes a plurality of electrical loads, an electrical energy source for supplying electrical energy to the plurality of electrical loads, a bus line for conducting the electrical energy from the electrical energy source to the plurality of electrical loads. The plurality of electrical loads are connected to the bus line and a group of a plurality of electronic fuses are electrically arranged between the electrical energy source and the plurality of electrical loads. The plurality of electronic fuses are separate from each other and are distributed in the electrical switching device. The electrical switching device also includes a control unit arranged in the bus line. The control unit is configured in such a way that the control unit can be used to address the plurality of electronic fuses in the group via the bus line.

### CROSS-REFERENCE TO RELATED APPLICATIONS

This application claims priority of European patent application no. 23171691.1, filed May 4, 2023, the entire content of which is incorporated herein by reference.

### BACKGROUND

The present disclosure relates to the integration of individual electronic fuses into a circuit. In most cases, a plurality of electronic fuses, rather than individual fuses, are inserted into an electrical switching device in order to protect a plurality of circuits independently of one another. As described in DE 10 2014 019 725 B3, in the case of a plurality of electronic fuses which are separate from one another and are distributed in the electrical switching device, it is advantageous or even necessary to operate these distributed electronic fuses in a manner dependent on one another. For example, when the supply voltage is switched on, the various electronic fuses are switched on one after the other so that inrush currents occur one after the other and not simultaneously (sequencing). Even if the minimum permissible input voltage is not reached due to overload, all electronic fuses are normally switched off until the input voltage has recovered. All other electronic fuses are then switched on again, except for the electronic fuses that resulted in overcurrent at the switching-off time.

Such dependent operation of the plurality of distributed electronic fuses requires coordination of the individual electronic fuses with each other. This is not easily possible. DE 10 2014 019 725 B3 provides a communication line for assigning addresses to the individual distributed electronic fuses. The arrangement of such a communication line is time-consuming and costly.

### SUMMARY

The disclosure is based on the object of developing a generic electrical switching device in such a way that dependent operation of the distributed electronic fuses is possible in a cost-effective and simple manner.

This object is achieved by an electrical switching device including: a plurality of electrical loads; an electrical energy source for supplying electrical energy to the plurality of electrical loads; a bus line for conducting the electrical energy from the electrical energy source to the plurality of electrical loads; the plurality of electrical loads being connected to the bus line; a group of a plurality of electronic fuses electrically arranged between the electrical energy source and the plurality of electrical loads; the plurality of electronic fuses being separate from each other and being distributed in the electrical switching device; and, a control unit being arranged in the bus line and being configured to address the plurality of electronic fuses in the group via the bus line.

According to the disclosure, a control unit is arranged in the bus line for conducting the electrical energy from the electrical energy source to the plurality of electrical loads. The control unit is configured in such a way that the control unit can be used to address the plurality of electronic fuses in the group via the bus line. According to the disclosure, the bus line already available for conducting the electrical energy is also used as a communication line for addressing the plurality of electronic fuses. This makes it possible to dispense with a communication line that is separate from the bus line and is intended to conduct the electrical energy. This allows the electrical switching device to be produced in a cost-effective and simple way. Dependent operation of the distributed individual electronic fuses in the group of the plurality of electronic fuses is possible in a simple and cost-effective manner. The electrical switching device can be compact.

In particular, the control unit contains a gateway. It may also be provided that the control unit is completely formed by a gateway. The gateway is used to establish a connection between two systems. The gateway represents the bridge for communication between the plurality of electronic fuses in the group and/or with a higher-level system, in particular with a control part of the control unit.

In particular, when addressing the group of the plurality of electronic fuses, a position of the electronic fuse to be addressed from the group relative to the other electronic fuses from the group in the electrical switching device is determined. In particular, the position with respect to the relative distance to the control unit along the bus line is determined. In particular, an address is then assigned to the electronic fuse to be addressed. The address consists of a name of the electronic fuse to be addressed and its position. The name of the electronic fuse is also referred to as the ID. Preferably, the address is assigned by the control unit.

The electrical energy source is expediently a power supply unit, in particular an AC/DC power supply unit. However, the power supply unit can also be a DC/DC power supply unit. The enclosure of the power supply unit is expediently configured using degree of protection IP20 to IP 69K, preferably using degree of protection IP54 to IP68, in particular using degree of protection IP 67 (DIN EN 60529 (VDE 0470-1): 2014-09 Degrees of protection provided by enclosures (IP code) (IEC 60529:1989+A1:1999+A2:2013)).

The electrical energy source advantageously supplies the plurality of electrical loads with DC voltage. The DC voltage is expediently a protective extra-low voltage. In particular, the protective extra-low voltage corresponds to a nominal voltage of 24 V or 48 V. Preferably, the plurality of electronic fuses in the group are addressed by modulating a useful signal onto the signal for transmitting the electrical energy. The signal for transmitting the electrical energy is referred to as a carrier, onto which the useful signal to be transmitted is modulated. In the present case, the useful signal is in particular a signal for addressing an electronic fuse. Possible modulation methods include in particular amplitude shift keying, frequency shift keying and phase shift keying.

Advantageously, the control unit is configured in such a way that the control unit can be used to address the plurality of electronic fuses in the group via the bus line.

In an embodiment of the disclosure, it is provided that the plurality of electronic fuses in the group are addressed successively in such a way that directly adjacent electronic fuses from the group of the plurality of electronic fuses are addressed in immediate succession with respect to the bus line.

In an first variant of the disclosure, it is provided that the electrical switching device includes a plurality of current measuring apparatuses. Each of the plurality of electronic fuses is expediently assigned a current measuring apparatus with a load resistor. At least part of the group of the plurality of electronic fuses belongs to an initial load group. The initial load group includes that electronic fuse in the group of the plurality of electronic fuses which is arranged furthest away from the electrical energy source along the bus line. The initial load group includes at least one further electronic fuse in the group of the plurality of electronic fuses, in particular all other electronic fuses in the group of the plurality of electronic fuses. The electrical switching device or the control unit is expediently configured such that,
when addressing the plurality of electronic fuses in the group, all load resistors in the initial load group are first connected to the bus line and load the electrical energy source,
the current measuring apparatuses assigned to the electronic fuses in the initial load group measure the current in the bus line downstream of the respectively associated electronic fuse, and
the control unit assigns an address, via the bus line, to that electronic fuse in the initial load group which is associated with a current measured value below an open-circuit current value of the electrical switching device, the address being linked to the position furthest away from the electrical energy source along the bus line.

In particular, the current measured value below the open-circuit current value of the electrical switching device is the smallest current measured value measured by all current measuring apparatuses. In this way, in a first step, an address can be easily assigned to that electronic fuse from the group of the plurality of electronic fuses which is furthest away from the electrical energy source along the bus line. In particular, only a single current measured value is below the open-circuit current value.

Advantageously, when addressing the group of the plurality of electronic fuses, it is provided that, after an address has been assigned to an electronic fuse, the load resistor belonging to this electronic fuse is disconnected from the bus line and remains disconnected during further addressing. When further addressing the group of the plurality of electronic fuses, the electrical energy source is expediently loaded by the load resistors in the initial load group that are still connected to the bus line. The current measuring apparatuses assigned to the electronic fuses in the initial load group advantageously measure the current in the bus line downstream of the respectively associated electronic fuse. “Downstream of” the electronic fuse means that the respective current measuring apparatus is at a greater distance from the electrical energy source, as measured along the bus line, than the respectively associated electronic fuse. In particular, the control unit assigns an address, via the bus line, to that electronic fuse of the electronic fuses in the initial load group with load resistors still connected to the bus line which is associated with a current measured value below the open-circuit current value of the electrical switching device. In particular, the current measured value below the open-circuit current value corresponds to the smallest of the current measured values measured by the current measuring apparatuses assigned to the electronic fuses in the initial load group with load resistors still connected to the bus line. The address assigned via the bus line is linked to that position of the electronic fuses in the initial load group with load resistors still connected to the bus line which is furthest away from the electrical energy source along the bus line. This further step when further addressing the group of the plurality of electronic fuses allows the next address to be easily assigned to that electronic fuse in the group which has hitherto not yet received an address and is at the same time furthest away from the electrical energy source along the bus line. This makes it possible to easily successively address the electronic fuses in the group.

As a result of the fact that the load resistor belonging to the electronic fuse that has just been addressed is disconnected from the bus line after each addressing operation has been carried out, the next electronic fuse can be addressed in the next addressing step.

The addressing expediently takes place until all load resistors in the initial load group are disconnected from the bus line. All electronic fuses in the initial load group are then addressed.

Advantageously, that electronic fuse from the initial load group whose load resistor is connected to the bus line and which is associated with the current measured value below the open-circuit current value of the electrical switching device sends a signal for requesting an address to the control unit. In particular, the signal for requesting an address is sent via the bus line. The control unit then expediently assigns an address to the electronic fuse, from which the signal for requesting an address that was emitted last originates, by emitting a corresponding signal via the bus line. This allows the control unit to easily control addressing centrally.

In particular, the signal sent by the control unit for assigning an address to that electronic fuse which last sent a signal for requesting an address to the control unit can be used to disconnect the load resistor, which belongs to this now addressed electronic fuse, from the bus line.

In an alternative, second variant of the disclosure, it is provided that the electrical switching device, in particular the control unit, is configured in such a way that, when addressing the plurality of electronic fuses in the group, apart from a first electronic fuse to be addressed in the group, none of the electronic fuses in the group initially load the electrical energy source, in particular via the bus line. The first electronic fuse in the group expediently loads the energy source via a defined, switchable impedance of the first electronic fuse. In particular, the defined, switchable impedance is a complex impedance. The complex impedance may include an ohmic impedance and/or a capacitive impedance. In particular, the remaining fuses of the plurality of electronic fuses in the group do not load the electrical energy source via the bus line. In particular, the remaining fuses of the plurality of electronic fuses in the group do not draw any energy from the energy source via the bus line. In particular, the remaining fuses of the plurality of electronic fuses represent a negligible impedance, in particular a negligible complex impedance. When addressing the plurality of electronic fuses in the group, the first electronic fuse to be addressed in the group represents a short circuit, in particular, at the start of addressing. Alternatively, it can also be provided that the bus line is interrupted by the first fuse to be addressed in that part of the bus line which faces away from the electrical energy source, with the result that the bus line has an open line end and is interrupted for subsequent electronic fuses. An AC voltage with a first frequency specified by the control unit is expediently applied to the bus line. In particular, the AC voltage with the first frequency specified by the control unit is applied to the bus line by the control unit. The control unit expediently determines a first phase shift between the current and voltage. Advantageously, the first frequency is determined in such a way that the first phase shift is ≤360°, in particular ≤180°. The distance between the first electronic fuse to be addressed and the control unit, in particular measured along the bus line, is advantageously determined, in particular in relation to the other electronic fuses in the group, on the basis of the first phase shift. In principle, the length of an open or closed line can be inferred on the basis of the phase shift between the current and voltage. The system represents a closed or open line because the first electronic fuse to be addressed in the group represents a short circuit or the bus line is interrupted. Basically, knowing whether the electronic fuse in the group represents a short circuit or whether the bus line is interrupted could be used to determine the length of the bus line from the control unit to the corresponding electronic fuse in absolute terms.

Advantageously, the dependence of the phase shift between the AC voltage and current on the frequency of the AC voltage can be used to carry out only a relative determination of the position of the electronic fuses. In an embodiment of the disclosure, the electrical switching device, in particular the control unit, is configured such that, after the first phase shift has been determined, apart from a second electronic fuse to be addressed in the group of the plurality of electronic fuses, none of the electronic fuses in the group load the electrical energy source, in particular via the bus line. The second electronic fuse in the group expediently loads the energy source via a defined, switchable impedance of the second electronic fuse. In particular, the defined, switchable impedance is a complex impedance. The complex impedance may include an ohmic impedance and/or a capacitive impedance. In particular, the remaining fuses of the plurality of electronic fuses in the group do not load the electrical energy source via the bus line. In particular, the remaining fuses of the plurality of electronic fuses in the group do not draw any energy from the energy source via the bus line. In particular, the remaining fuses of the plurality of electronic fuses represent a negligible impedance, in particular a negligible complex impedance.

The second electronic fuse to be addressed in the group then represents a short circuit in particular. Alternatively, it can also be provided that the bus line is interrupted by the second fuse to be addressed in that part of the bus line which faces away from the electrical energy source, with the result that the bus line has an open line end and is interrupted for subsequent electronic fuses.

The AC voltage is expediently changed by the control unit, starting from the first frequency to a second frequency, such that the first phase shift between the AC voltage and current determined for the first electronic fuse to be addressed is present. Advantageously, the control unit decides, on the basis of a comparison between the second frequency and the third frequency, whether the first electronic fuse to be addressed or the second electronic fuse to be addressed is further away from the control unit along the bus line. This provides a simple method for determining the relative positions of the electronic fuses to be addressed. When addressing the electronic fuses in the group, names for the electronic fuses to be addressed can first be assigned and then each name can be assigned a position relative to the other electronic fuses in the group. However, it may also be provided that the position of the electronic fuse to be addressed is first determined and then a name is assigned to the electronic fuse to be addressed. This name is then linked to the position. The link between the name and position is called an address. The term name corresponds to the term ID.

In particular, the AC voltage is sinusoidal.

Advantageously, after determining the second frequency, the control unit assigns an address, via the bus line, at least to the first electronic fuse to be addressed and to the second electronic fuse to be addressed. That electronic fuse which is associated with the higher frequency is linked to a position closer to the control unit along the bus line. This approach is based on the fact that, for a longer line, a lower frequency of the AC voltage is required in order to achieve the same phase shift between the AC voltage and current than for a shorter line.

Advantageously, the first frequency is selected in such a way that the phase shift is a multiple of 90°. In particular, the first frequency is selected in such a way that the phase shift is a multiple of 180°, expediently 180°. This has the advantage that the phase shifts can each be measured at times when the voltage or current is zero. With a phase shift of only 90° or, for example, of 270°, the real part can be zero.

Advantageously, the current intensity is measured as a time-discrete signal for determining the phase shift. In order to select the first frequency such that the first phase shift is a multiple of 180°, in particular 180°, the current intensity is expediently measured at a zero crossing of the AC voltage. In particular, the frequency of the AC voltage is changed, starting from a frequency with a phase shift of less than 180° or less than 360°, such that the current intensity is approximately zero, in particular zero. In this way, it is easily possible to determine the first frequency in such a way that the phase shift is 180°. In order to determine the second frequency, the frequency of the AC voltage is expediently selected in such a way that the current intensity is approximately zero at a zero crossing of the AC voltage. This means that, when the AC voltage with the second frequency is applied, the phase shift simply corresponds to the first phase shift, in this case 180°.

In particular, the current intensity is measured at the location at which the voltage is generated.

In an alternative, third variant of the disclosure, each of the plurality of electronic fuses in the group is assigned an addressing apparatus. When addressing the plurality of electronic fuses in the group, one addressing signal each expediently runs through at least one part of the bus line for addressing each electronic fuse. In particular, each addressing apparatus is configured in such a way that it can prevent the addressing signal from being conducted to the directly adjacent electronic fuse in the group along the bus line. In particular, this involves in each case the neighbor who is further away from the electronic energy source. Advantageously, the electrical switching device is configured in such a way that the addressing apparatus of an electronic fuse which has received an address then causes the directly adjacent electronic fuse in the group along the bus line to be addressed. In particular, this is the directly adjacent electronic fuse along the bus line, which is arranged further away from the electrical energy source along the bus line than the previously addressed electronic fuse. In particular, in turn, an addressing signal is conducted at least via part of the bus line for conducting the electrical energy line. This means that no extra line must be provided for addressing the electronic fuse in the group.

In an embodiment of the third variant of the disclosure, it is provided that all addressing apparatuses have a damping apparatus. In particular, the damping apparatus of a specific electronic fuse in the group can prevent the addressing signal from being conducted to that electronic fuse in the group which is directly adjacent to the specific electronic fuse along the bus line. The damping apparatus can be used to ensure that initially only the specific electronic fuse is addressed and none of the electronic fuses in the group which are downstream of the specific electronic fuse with respect to the bus line and the electrical energy source (that is, further away from the electrical energy source or the control unit along the bus line). When addressing the plurality of electronic fuses in the group via the bus line, all damping apparatuses, in particular in the bus line, expediently initially act in such a way that an addressing signal is prevented from being conducted in the bus line between two electronic fuses in the group that are directly adjacent along the bus line (3). The control unit then emits, via the bus line, a first addressing signal which passes, without being disturbed by the damping apparatuses, to the electronic fuse that is closest to the control unit along the bus line. In this way, an address that is linked to the position closest to the control unit along the bus line is assigned to this electronic fuse. The damping apparatus belonging to the addressed electronic fuse expediently prevents the first addressing signal from being conducted to the electronic fuse located directly adjacent to the addressed electronic fuse along the bus line.

Advantageously, it is provided that, when addressing the plurality of electronic fuses in the group, after an address has been assigned to a specific electronic fuse, this specific electronic fuse initiates the damping apparatus associated with the specific electronic fuse being switched off and a further addressing signal being emitted by the control unit. Alternatively, it may be provided that, when addressing the plurality of electronic fuses in the group, after an address has been assigned to a specific electronic fuse, this specific electronic fuse initiates a further addressing signal being generated by the addressing apparatus belonging to the electronic fuse addressed last and this further addressing signal being passed to the bus line for addressing that electronic fuse in the group which is directly adjacent to the electronic fuse addressed last along the bus line. In particular, this addressing signal is passed to that part of the bus line which, with respect to the control unit, is downstream of the damping apparatus belonging to the electronic fuse addressed last along the bus line. Advantageously, the electrical switching device is configured in such a way that the further addressing signal is then used to assign an address, via the bus line, to the electronic fuse directly adjacent to the electronic fuse addressed last along the bus line, the address being linked to the position located closest to the electronic fuse addressed last along the bus line. This address is linked to a position further away from the electrical energy source along the bus line than the previously addressed electronic fuse.

In particular, the electrical switching device is configured in such a way that the addressing of the group of the plurality of electronic fuses is continued successively until all of the plurality of electronic fuses in the groups have been addressed. This addressing method makes it possible to easily and quickly address all electronic fuses without an additional communication line. The bus line already used to conduct the electrical energy can be used to address the electronic fuses in the group.

In an embodiment of a method for addressing electronic fuses in an electrical switching device, the electrical switching device includes:
a plurality of electrical loads,
an electrical energy source for supplying electrical energy to the plurality of electrical loads,
a bus line for conducting the electrical energy from the electrical energy source to the plurality of electrical loads, the plurality of electrical loads being connected to the bus line, in particular via stub lines in each case,
a plurality of electronic fuses electrically arranged between the electrical energy source and the plurality of electrical loads, in particular in the stub lines, the plurality of electronic fuses being separate from each other, the plurality of electronic fuses being distributed in the electrical switching device.

In accordance with the method, the plurality of electronic fuses are addressed via the bus line. The other concrete features described can also be carried out in the form of a method.

### BRIEF DESCRIPTION OF DRAWINGS

The invention will now be described with reference to the drawings wherein:

FIG. 1 shows a schematic illustration of an electrical switching device having a plurality of electrical loads and a plurality of electronic fuses which are distributed in the electrical switching device and are supplied with electrical energy from an electrical energy source via a bus line;

FIG. 2 shows a schematic illustration of an electrical switching device according to FIG. 1, wherein the electrical switching device according to FIG. 2 additionally has a data line which is separate from the bus line and connects a control unit to the electronic fuses;

FIG. 3 and FIG. 4 show schematic illustrations of different configurations of the switching device from FIG. 1 with different devices for addressing the electronic fuses via the bus line;

FIG. 5 shows a schematic illustration of a Smith chart for illustrating the addressing of the electronic fuses via the bus line via the electrical switching device from FIG. 1 with the device for addressing the electronic fuses according to FIG. 4;

FIG. 6 shows schematic illustrations of different configurations of the switching device from FIG. 1 with different devices for addressing the electronic fuses via the bus line; and,

FIG. 7 shows schematic illustrations of different configurations of the switching device from FIG. 1 with different devices for addressing the electronic fuses via the bus line.

### DETAILED DESCRIPTION

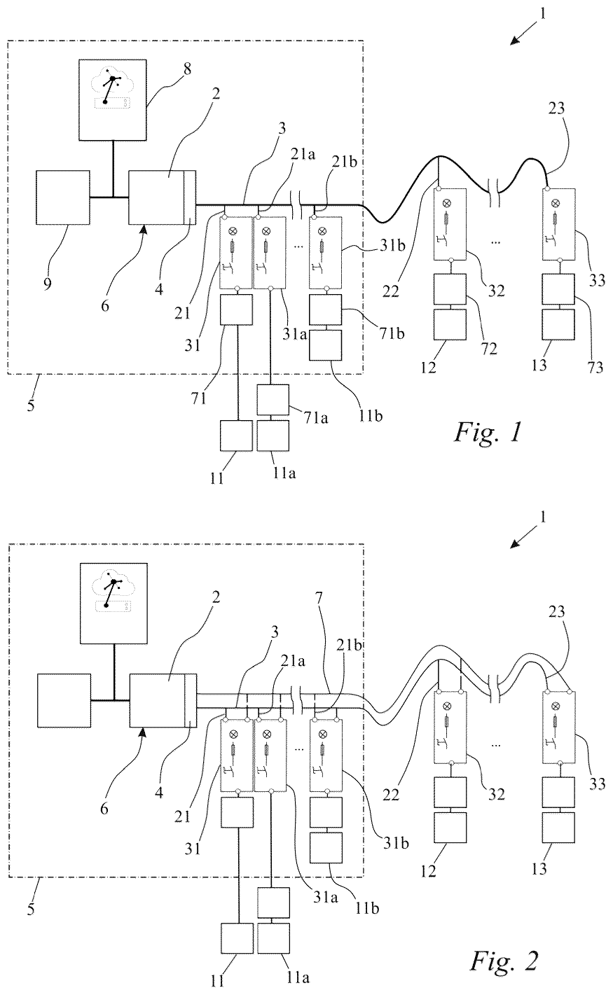

FIG. 1 shows an electrical switching device 1. The electrical switching device 1 can be used, for example, in an industrial installation, for example, in an automation installation or an intralogistics installation. Such industrial installations can be, for example, production installations and/or conveying installations. The electrical switching device 1 includes a plurality of electrical loads 11, 11a, 11b, 12 and 13. The plurality of electrical loads 11, 11a, 11b, 12 and 13 are distributed in the electrical switching device 1. The electrical loads 11, 11a, 11b, 12 and 13 can be actuators and/or sensors. The electrical switching device 1 includes an electrical energy source 2.

The electrical energy source 2 is used to supply electrical energy to the plurality of electrical loads 11, 11a, 11b, 12 and 13. In the embodiment, the electrical energy source 2 is a voltage source. In particular, the electrical energy source 2 is a power supply unit. In the embodiment, the electrical energy source 2 is an AC/DC power supply unit. However, the power supply unit may also be a DC/DC power supply unit. The enclosure 6 of the electrical energy source 2 can be configured using degree of protection IP67 (DIN EN 60529 (VDE 0470-1):2014-09 Degrees of protection provided by enclosures (IP code) (IEC 60529:1989+A1:1999+A2:2013)). This makes it possible to also arrange the electrical energy source 2 outside a switchgear cabinet. The electrical energy source 2 supplies DC voltage to the plurality of electrical loads 11, 11a, 11b, 12 and 13. The DC voltage is a protective extra-low voltage. In the embodiment, the protective extra-low voltage corresponds to a nominal voltage of 24 V. However, the protective extra-low voltage can also correspond to a nominal voltage of 48 V.

The electrical switching device 1 includes a bus line 3. The bus line 3 is used to conduct the electrical energy from the electrical energy source 2 to the plurality of electrical loads 11, 11a, 11b, 12 and 13. The plurality of electrical loads 11, 11a, 11b, 12 and 13 are each connected to the bus line 3, in particular via stub lines 21, 21a, 21b, 22 and 23.

The electrical switching device 1 includes a group of a plurality of electronic fuses 31, 31a, 31b, 32 and 33. The electronic fuses 31, 31a, 31b, 32 and 33 in the group are electrically arranged between the electrical energy source 2 and the plurality of electrical loads 11, 11a, 11b, 12 and 13, in particular in the stub lines 21, 21a, 21b, 22 and 23. The electronic fuses 31, 31a, 31b, 32 and 33 are separate from one another. The electronic fuses 31, 31a, 31b, 32 and 33 are distributed in the electrical switching device 1.

In the embodiment, the electrical switching device 1 is arranged at least partially in a switchgear cabinet 5. The electronic fuses 31, 31a, 31b, 32 and 33 are arranged at least partially outside the switchgear cabinet 5. In the embodiment, the electronic fuses 31, 31a and 31b of the plurality of electronic fuses are arranged within the switchgear cabinet 5. However, it may also be provided that the plurality of electronic fuses 31, 31a, 31b, 32 and 33 in the group are arranged exclusively outside a switchgear cabinet 5. It can also be provided that no switchgear cabinet 5 is present at all and that the switching device 1 is arranged completely outside a switchgear cabinet. In the embodiment, at least the electronic fuses 32 and 33 in the group of the plurality of electronic fuses 31, 31a, 31b, 32 and 33 are arranged outside the switchgear cabinet 5. The electronic fuses 32 and 33 are distributed in the area of the industrial installation. In the embodiment, the electronic fuses 31, 31a and 31b, in particular their enclosures, are configured using degree of protection IP20 (DIN EN 60529 (VDE 0470-1):2014-09 Degrees of protection provided by enclosures (IP code) (IEC 60529:1989+A1:1999+A2:2013)). The electronic fuses 32 and 33, in particular their enclosures, are configured using degree of protection IP54 or degree of protection IP67 (DIN EN 60529 (VDE 0470-1):2014-09 Degrees of protection provided by enclosures (IP code) (IEC 60529:1989+A1:1999+A2:2013)).

The electrical switching device 1 includes a control unit 4. The control unit 4 is arranged in the bus line 3. In all embodiments, the electrical switching device 1 is configured in such a way that the control unit 4 can communicate as a gateway with the distributed plurality of electronic fuses 31, 31a, 31b, 32, 33 in the group. The control unit 4 is integrated into the electrical energy source 2.

The electrical energy source 2 includes an enclosure 6. The control unit 4 is expediently arranged in the enclosure 6 of the electrical energy source 2.

The enclosure 6 is closed on all sides. The enclosure 6 is configured using degree of protection IP20 to IP69K. The enclosure 6 is preferably configured using degree of protection IP54 to IP68. These degrees of protection are defined in the standard “DIN EN 60529 (VDE 0470-1):2014-09 Degrees of protection provided by enclosures (IP code)”.

The enclosure 6 has an output. The electrical energy source 2 is connected to the bus line 3 through the output. The electrical energy source 2 is electrically connected to the output via an energy line. The electrical energy source provides a regulated and monitored voltage at the output. Only the control unit 4 is arranged as a further component in the energy line. The control unit 4 is electrically arranged between the output of the enclosure 6 and the energy source 2. In the embodiment, the energy source 2 is a voltage source.

The electrical energy source 2 and the control unit 4 are configured as a structural unit. The structural unit can be inserted into and/or removed from the electrical switching device 1 as a whole.

The electrical switching device 1 is configured in such a way that the control unit 4 can communicate with the distributed plurality of electronic fuses 31, 31a, 31b, 32, 33 in the group in such a way that the plurality of electronic fuses 31, 31a, 31b, 32, 33 in the group can be addressed via the control unit 4. The plurality of electronic fuses 31, 31a, 31b, 32, 33 in the group can be addressed using the control unit.

According to the embodiment according to FIG. 1, the control unit 4 is configured in such a way that the control unit 4 can be used to address the plurality of electronic fuses 31, 31a, 31b, 32 and 33 in the group via the bus line 3 for conducting the electrical energy. In the embodiment according to FIG. 1, no additional data line is required for addressing all of the plurality of electronic fuses 31, 31a, 31b, 32 and 33. All electronic fuses 31, 31a, 31b, 32 and 33 are addressed via the bus line 3 for conducting the electrical energy from the electrical energy source 2 to the plurality of electrical loads 11, 11a, 11b, 12 and 13.

In the embodiment, the plurality of electronic fuses 31, 31a, 31b, 32, 33 in the group are addressed by modulating the signal conducted in the bus line 3 for transmitting the electrical energy from the electrical energy source 2 to the electrical loads 11, 11a, 11b, 12, 13. This signal for transmitting the electrical energy is called a carrier. The useful signal to be transmitted, in particular the signal for addressing an electronic fuse from the group of the plurality of electronic fuses 31, 31a, 31b, 32, 33, is modulated onto the carrier. Possible modulation methods include in particular amplitude shift keying, frequency shift keying and phase shift keying. The Bell 202 modem standard or a higher standard can be used as a frequency shift keying modulation method. More complex methods can also be used to modulate the energy signal. In this respect, quadrature amplitude modulation and quadrature phase shift keying should be mentioned.

The control unit 4 communicates on the one hand with the electronic fuses 31, 31a, 31b, 32, 33 and on the other hand with data sources and consumers. These include, for example, the edge gateway 8 and the controller 9. The edge gateway 8 is used to communicate with the cloud. Communication with these devices, namely the edge gateway 8 and the controller 9, takes place at a higher level. Ethernet-based field buses or IO links as well as field bus protocols such as ProfiNet, EtherCAT, Ethernet/IP, OPC/UA or MQTT can be provided for communication at this level.

The control unit 4 communicates with the plurality of electronic fuses 31, 31a, 31b, 32 and 33 at a lower level. The control unit collects the data transmitted here from the plurality of electronic fuses 31, 31a, 31b, 32, 33 and transfers them to the data sources and consumers as part of communication at the higher level, if necessary after further processing.

The control unit 4 includes a gateway in the embodiment. Gateway is used to denote a component that establishes a connection between two systems. The gateway represents the bridge for communication between a plurality of internal or external network sections.

A field controller 71, 71a, 71b, 72, 73 is provided between the electronic fuse 31, 31a, 31b, 32, 33 and the electrical load 11, 11a, 11b, 12, 13. The field controller 71, 71a, 71b, 72, 73 is arranged in the respective stub line 21, 21a, 21b, 22, 23. The field controller 71, 71a, 71b, 72, 73 can be a motor controller, a contactor or the like.

When addressing the group of the plurality of electronic fuses 31, 31a, 31b, 32, 33, a position of the electronic fuse 31, 31a, 31b, 32, 33 to be addressed from the group relative to the other electronic fuses 31, 31a, 31b, 32, 33 from the group in the electrical switching device 1 is determined and then an address is assigned to the electronic fuse 31, 31a, 31b, 32, 33 to be addressed. In the embodiment, the address is assigned by the control unit 4. However, it can also be provided that the address is assigned by the electronic fuse 31, 31a, 31b, 32, 33 itself. The address consists of a name of the electronic fuse 31, 31a, 31b, 32, 33 to be addressed and its position. The name is also referred to as the ID. During addressing, a position of the electronic fuse 31, 31a, 31b, 32, 33 in the switching device 1, in particular along the bus line 3 relative to the other electronic fuses 31, 31a, 31b, 32, 33 in the group, is determined. The ID is linked to this position. The address is assigned.

In the embodiments, the electrical switching device 1 is configured in such a way that the plurality of electronic fuses 31, 31a, 31b, 32, 33 are addressed successively in such a way that directly adjacent electronic fuses 31, 31a, 31b, 32, 33 from the group of the plurality of electronic fuses 31, 31a, 31b, 32, 33 are addressed in immediate succession with respect to the bus line 3.

FIG. 2 shows a variant of the switching device 1 according to FIG. 1. The description of FIG. 1 applies to FIG. 2, unless the communication between the plurality of electronic fuses 31, 31a, 31b, 32, 33 and/or with the control unit 4 via the bus line 3 for conducting the electrical energy is affected. This concerns in particular the addressing of the plurality of electronic fuses 31, 31a, 31b, 32, 33 via the bus line 3 for conducting the electrical energy. In the embodiment according to FIG. 2, as an alternative to the embodiment according to FIG. 1, a data line 7 separate from the bus line 3 for conducting the electrical energy is provided for the communication between the plurality of electronic fuses 31, 31a, 31b, 32, 33 and/or with the control unit 4.

The control unit 4 is connected to the distributed plurality of electronic fuses 31, 31a, 31b, 32, 33 in the group, for the purpose of communicating with the group of the plurality of electronic fuses 31, 31a, 31b, 32, 33, via the data line 7 which is separate from the bus line 3 for conducting the electrical energy. In FIG. 2, the bus line 3 is used exclusively to transmit energy, that is, as a power-carrying line. A transmission of data via the bus line 3 is not provided in the embodiment according to FIG. 2.

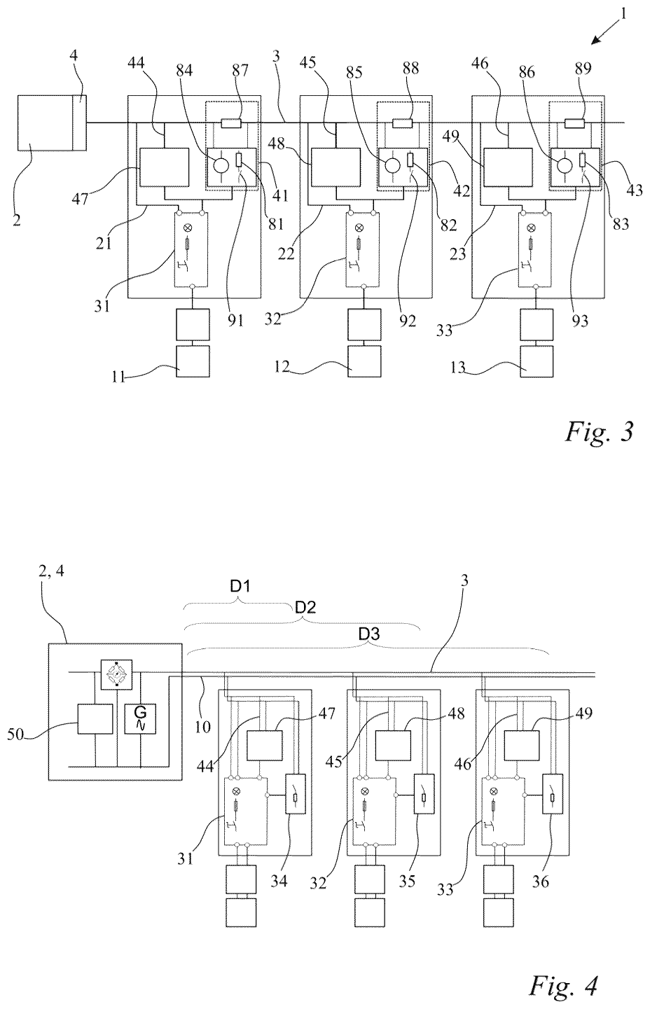

For the realization of the address assignment based on the configuration according to FIG. 1, the electrical switching device 1 can be configured in different ways. FIGS. 3, 4, 6 and 7 show the corresponding details of the switching device 1 from FIG. 1 in the different variants. In FIG. 1, the area of the switching device 1 between the bus line 3 and the plurality of electronic fuses 31, 31a, 31b, 32, 33 is not shown in detail. This area may be configured according to one of FIGS. 3, 4, 6 and 7. Here, different devices are arranged electrically between the bus line 3 and the respective electronic fuse 31, 31a, 31b, 32 or 33. These devices are shown in FIGS. 3, 4, 6 and 7 as examples of individual electronic fuses. The configuration for an electronic fuse is also used for the respective other electronic fuses of the electrical switching device.

The addressing of the plurality of electronic fuses 31, 31a, 31b, 32, 33 via the device from FIG. 3 can be referred to as current measurement addressing. In this configuration of the electrical switching device 1, the electrical switching device 1 includes a plurality of current measuring apparatuses 41, 42, 43. Each of the plurality of electronic fuses 31, 32, 33 is assigned a respective current measuring apparatus 41, 42, 43. The current measuring apparatus 41, 42, 43 includes a load resistor 81, 82, 83. The load resistor 81 belongs to the current measuring apparatus 41, the load resistor 82 belongs to the current measuring apparatus 42 and the load resistor 83 belongs to the current measuring apparatus 43. In particular, the load resistor 81, 82, 83 is arranged in the bus line 3. At least part of the group of the plurality of electronic fuses 31, 32, 33, all electronic fuses 31, 32, 33 in the group in the embodiment according to FIG. 3 (including the electronic fuses 31a, 31b not shown in FIG. 3), belong to an initial load group. The initial load group includes:
that electronic fuse 33 in the group of the plurality of electronic fuses 31, 32 33 which is arranged furthest away from the electrical energy source 2 along the bus line 3 and
at least one further electronic fuse 31, 32, all electronic fuses 31, 32, 33 in the embodiment according to FIG. 3 (including the electronic fuses 31a, 31b not shown in the embodiment according to FIG. 3), in the group of the plurality of electronic fuses 31, 32, 33.

The electrical switching device 1, in particular the control unit 4, is configured such that, when addressing the plurality of electronic fuses 31, 32, 33 in the group, all load resistors 81, 82, 83 in the initial load group are first connected to the bus line 3 and load the electrical energy source 2. The current measuring apparatuses 41, 42, 43 assigned to the electronic fuses 31, 32, 33 in the initial load group measure the current in the bus line 3 downstream of the respectively associated electronic fuse 31, 32, 33. The control unit 4 assigns an address, via the bus line 3, to that electronic fuse 33 in the initial load group which is associated with a current measured value below an open-circuit current value of the electrical switching device 1, the address being linked to the position furthest away from the electrical energy source 2 along the bus line 3. This current measured value corresponds in particular to the smallest current measured value measured by the current measuring apparatuses 41, 42, 43. In particular, there is only a single current measured value below the open-circuit current value. During idling, no electrical load 11, 12, 13 is connected to the electrical energy source 2 or none of the electrical loads 11, 12, 13 are operated in the switched-on state. When addressing the electronic fuse 31, 32, 33, the electrical loads 11, 12, 13 are either disconnected from the bus line 3 or are not operated in the switched-on state. In other words, the electrical loads 11, 12, 13 do not draw electrical current from the electrical energy source 2 during the addressing of the electronic fuses 31, 32, 33.

The current measuring apparatus 41, 42, 43 includes a switch 91, 92, 93 in the embodiment. The switch 91 is assigned to the current measuring apparatus 41, the switch 92 is assigned to the current measuring apparatus 42 and the switch 93 is assigned to the current measuring apparatus 43. The switch 91, 92, 93 can be used to connect the respectively assigned load resistor 81, 82, 83 to, in particular into, the bus line 3 and to disconnect it from the bus line 3. In the embodiment according to FIG. 3, the load resistor 81, 82, 83 is connected to the bus line 3 when the switch 91, 92, 93 is open. When the switch 91, 92, 93 is closed, the respectively assigned load resistor 81, 82, 83 is not connected to the bus line 3. A defined load is connected to the bus line 3 by connecting the load resistor 81, 82, 83. This defined load of a single load resistor 81, 82, 83 is greater than the total expected load when the electrical switching device 1 is operated at idling speed. The load resistor 81, 82, 83 is an ohmic resistor.

The electronic fuse 31, 32, 33 is connected to the bus line 3 via a connecting line 44, 45, 46. The connecting line 44 is assigned to the electronic fuse 31, the connecting line 45 is assigned to the electronic fuse 32 and the connecting line 46 is assigned to the electronic fuse 33. A shift keying modem 47, 48, 49 is arranged in the connecting line 44, 45, 46. The shift keying modem 47, 48, 49 is used for communication between the electronic fuse 31, 32, 33 and the control unit 4. In the embodiment, communication is carried out via frequency shift keying. Accordingly, the shift keying modem 47, 48, 49 is a frequency shift keying modem. However, amplitude shift keying or phase shift keying may also be provided as a modulation method. The modem is then accordingly an amplitude shift keying modem or a phase shift keying modem. This also applies to the other embodiments. In the embodiments, the shift keying modem 47 is assigned to the electronic fuse 31, the shift keying modem 48 is assigned to the electronic fuse 32 and the shift keying modem 49 is assigned to the electronic fuse 33. The electronic fuse 31, 32, 33 can modulate a signal onto the electrical signal running in the bus line 3 via the shift keying modem 47, 48, 49. The electronic fuse 31, 32, 33 can receive or demodulate a signal modulated onto the electrical signal running in the bus line 3 via the shift keying modem 47, 48, 49. This is effected via frequency shift keying. This allows data to be exchanged between the electronic fuse 31, 32, 33 and the control unit 4. In particular, data can be transmitted from the electronic fuse 31, 32, 33 to the control unit 4. In the embodiment according to FIG. 3, the shift keying modem 47, 48, 49 is used to transmit the respective current measured values to the control unit 4. The control unit 4 can compare the current measured values obtained in this manner with the open-circuit current value and assign the address to that electronic fuse 33 from which a current measured value below the open-circuit current value is transmitted, the address being linked to the position furthest away from the electrical energy source 22 along the bus line 3. However, it may also be provided that the electronic fuses 31, 32, 33 themselves carry out this comparison.

The current measuring apparatus 41, 42, 43 includes a voltmeter 84, 85, 86. The voltmeter 84 is assigned to the current measuring apparatus 41, the voltmeter 85 is assigned to the current measuring apparatus 42 and the voltmeter 86 is assigned to the current measuring apparatus 43. The voltmeter 84, 85, 86 is used to measure the voltage dropped across an assigned measuring resistor 87, 88, 89 and thus to determine the current intensity in the bus line 3. The measuring resistor 87, 88, 89 is arranged in the bus line 3. The measuring resistor 87 is assigned to the current measuring apparatus 41, the measuring resistor 88 is assigned to the current measuring apparatus 42 and the measuring resistor 89 is assigned to the current measuring apparatus 43.

When addressing the group of the plurality of electronic fuses 31, 32, 33 according to current measurement addressing, after an address has been assigned to an electronic fuse, the associated load resistor 81, 82, 83 is disconnected from the bus line 3. In the embodiment according to FIG. 3, this is done by bridging the load resistor 81, 82, 83. During further addressing, the load resistor 81, 82, 83 remains disconnected. When further addressing the group of the plurality of electronic fuses 31, 32, 33, the electrical energy source 2 is loaded by the load resistors 81, 82, 83 in the initial load group that are still connected to the bus line 3. In the embodiment according to FIG. 3, for example, the electronic fuse 33 is addressed first. The associated load resistor 83 is then disconnected from the bus line 3 by way of bridging by closing the associated switch 93. When further addressing the group of the plurality of electronic fuses 31, 32, 33, the remaining load resistors, the load resistors 81 and 82 in FIG. 3, still load the electrical energy source 2. The current measuring apparatuses 41, 42, 43 assigned to the electronic fuses 31, 32, 33 in the initial load group measure the current in the bus line 3 downstream of the respectively associated electronic fuse 31, 32, 33. This applies in particular to the current measuring apparatuses 41 and 42, whose load resistors 81 and 82 are still connected to the bus line 3. The control unit 4 assigns an address, via the bus line 3, to that electronic fuse 31, 32 of the electronic fuses 31, 32 in the initial load group with load resistors 81, 82 still connected to the bus line 3 which is associated with a current measured value below the open-circuit current value of the electrical switching device 1. This address is linked to that position of the electronic fuses 31, 32 in the initial load group with load resistors 81, 82 still connected to the bus line 3 which is furthest away from the electrical energy source 2 along the bus line 3. Again, the current measured value below the open-circuit current value corresponds to the smallest current measured value measured by the current measuring apparatuses 41, 42 with load resistors 81, 82 still connected to the bus line 3. Again, there is only a single current measured value below the open-circuit current value. In the embodiment according to FIG. 3, after the electronic fuse 33 which is furthest away from the control unit 4 along the bus line 3 has been addressed, the electronic fuse 32 is addressed. The electronic fuse 32 is the electronic fuse which is furthest away from the control unit 4 and has not yet been addressed. As before, after the electronic fuse 32 has been addressed, the associated load resistor 82 is disconnected from the bus line 3. This load resistor 82 also remains disconnected during further addressing. The group of the plurality of electronic fuses 31, 32, 33 is addressed until all load resistors 81, 82, 83 in the initial load group are disconnected from the bus line 3.

That electronic fuse 31, 32, 33 from the initial load group, whose load resistor 81, 82, 83 is connected to the bus line 3 and which is associated with a current measured value below the open-circuit current value of the electrical switching device 1, sends a signal for requesting an address to the control unit 4. In the embodiment according to FIG. 3, this is done by way of the respective shift keying modem 47, 48, 49. After receiving this signal for requesting an address, the control unit 4 sends an addressing signal for addressing the electronic fuse 31, 32, 33 to the corresponding electronic fuse 31, 32, 33, wherein the address of the electronic fuse 31, 32, 33 is linked to the determined relative position relative to the other electronic fuses 31, 32, 33. In this way, the corresponding electronic fuse 31, 32, 33 is addressed.

FIG. 4 shows an alternative configuration of the area between the bus line 3 and the electronic fuses 31, 31a, 31b, 32, 33 of the electrical switching device from FIG. 1. Again, only three electronic fuses 31, 32, 33 are shown by way of example. However, the respective configuration can also be applied to the further electronic fuses 31a and 31b (FIG. 1). In addition, a ground conductor 10 is depicted in FIG. 4. The ground conductor 10 can also be used in the other embodiments in this form. The addressing of the plurality of electronic fuses via the device according to FIG. 4 is also referred to as impedance measurement addressing.

In impedance measurement addressing, the electrical circuit 1, in particular the control unit 4, is configured in such a way that, when addressing the plurality of electronic fuses 31, 32, 33 in the group, apart from a first electronic fuse 31 to be addressed in the group, none of the electronic fuses 32, 33 in the group initially load the electrical energy source 2. For the description of the embodiment, it is assumed that the electronic fuse 31 which is shown in FIG. 4 and is closest to the control unit 4 along the bus line 3 first loads the energy source. However, it is also possible to start with any other electronic fuse 31, 32, 33 in the group of the plurality of electronic fuses 31, 32, 33.

In particular, apart from a first electronic fuse 31 to be addressed in the group, none of the electronic fuses 32, 33 in the group draw energy from the electrical energy source 2 via the bus line 3. The first electronic fuse 31 to be addressed in the group loads the energy source 2 via a defined, switchable impedance of the first electronic fuse 31. In particular, the defined, switchable impedance is a complex impedance 34. The complex impedance 34 may include an ohmic impedance and/or a capacitive impedance. The remaining fuses of the plurality of electronic fuses 32, 33 in the group do not load the electrical energy source 2 via the bus line 3. In particular, the remaining fuses of the plurality of electronic fuses 32, 33 represent a negligible impedance, in particular a negligible complex impedance. When addressing the plurality of electronic fuses 31, 32, 33 in the group, the first electronic fuse 31 to be addressed in the group represents a short circuit, in particular, at the start of addressing. Alternatively, it can also be provided that the bus line 3 is interrupted by the first fuse 31 to be addressed in that part of the bus line 3 which faces away from the electrical energy source 2, with the result that the bus line 3 has an open line end and is interrupted for subsequent electronic fuses 32, 33.

An AC voltage is applied to the bus line 3. The frequency of the AC voltage is specified by the control unit 4. In particular, the AC voltage is applied to the bus line 3 by the control unit 4. The control unit 4 determines a first phase shift between the AC voltage and the current. The first frequency of the AC voltage is selected such that the first phase shift is less than 360°, in particular less than 190°.

With line theory, an infinitesimal (“infinitely short”) line section of the bus line can be described via an equivalent circuit diagram consisting of concentrated components, as soon as the wavelength of the signals transmitted in the line is of the order of magnitude of the line length. This is especially the case for particularly high frequencies of the AC voltage. In the present case, the switching device 1, in particular the bus line 3 and the applied AC voltage, satisfies the conditions for the bus line not being able to be seen as an ohmic impedance in a simplified way, but having to be subdivided into infinitesimally small line sections based on line theory, which sections can be described by an equivalent circuit diagram consisting of concentrated components, in particular capacitances and inductances. Therefore, the first phase shift between the AC voltage and current occurs when a high-frequency AC voltage is applied. In the embodiment according to FIG. 4, the frequency of the AC voltage in the presence of the first phase shift is greater than 100 kHz, in particular greater than 1 MHz, preferably greater than 100 MHz.

As shown in FIG. 4, the first electronic fuse 31 to be addressed is arranged at a first distance D1 from the control unit 4, as measured along the bus line 3. The second electronic fuse 32 to be addressed is arranged at a second distance D2 from the control unit 4, as measured along the bus line 3. The third electronic fuse 33 to be addressed is arranged at a third distance D3 from the control unit 4, as measured along the bus line 3. The first distance D1 between the first electronic fuse 31 to be addressed and the control unit 4 is determined based on the first phase shift. In particular, the control unit 4 determines the distance D1. This can be done with knowledge of the physical properties of the bus line 3 in such a way that the first distance D1 is determined in absolute terms. In the embodiment, however, the distance D1 is determined only in relation to the other distances D2, D3 of the other electronic fuses 32, 33 in the group.

Each of the electronic fuses 31, 32, 33 in the group is respectively assigned a complex impedance 34, 35, 36. The complex impedance 34 is assigned to the electronic fuse 31, the complex impedance 35 is assigned to the electronic fuse 32 and the complex impedance 36 is assigned to the electronic fuse 33. In the embodiment according to FIG. 4, the complex impedance 34, 35, 36 is part of the respective electronic fuse 31, 32, 33. The complex impedance 34, 35, 36 can be switched. The complex impedance 34, 35, 36 is arranged electrically between the bus line 3 and the ground conductor 10 together with the assigned electronic fuse 31, 32, 33. So that, apart from the first electronic fuse 31 to be addressed in the group, none of the electronic fuses 32, 33 in the group initially load the electrical energy source 2, in particular via the bus line 3, when addressing the plurality of electronic fuses 31, 32, 33 in the group, only the complex impedance 34 assigned to the first electronic fuse 31 to be addressed is initially closed. The remaining complex impedances 35 and 36 are open. When addressing the first electronic fuse 31, the first complex impedance 34 is connected for a defined time to the supply line configured as a bus line 3. All other complex impedances 35, 36 are open for this period. It may also be provided that the electronic fuses 32, 33 belonging to the open complex impedances 35, 36 are electrically disconnected from the electrical energy source 2 or from the bus line 3 during this period in such a way that they are cut off from the supply of the electrical energy source 2. It may be provided that the electronic fuses 32 and 33 are supplied from an internal energy storage device during this period.

In the embodiment according to FIG. 4, it is provided that, after the first phase shift has been determined, the control unit 4 causes the first electronic fuse 31 to be addressed to no longer load the electrical energy source 2, in particular to no longer load it via the bus line 3. In the embodiment, the complex impedance 34 is opened for this purpose. The control unit then causes none of the electronic fuses 31, 33 in the group, apart from the second electronic fuse 32 to be addressed in the group of the plurality of electronic fuses 31, 32, 33, to load the electrical energy source 2. However, it may also be provided that another electronic fuse 33 loads the energy source 2 after the first phase shift has been determined. In particular, any electronic fuse 32, 33 for which no phase shift has yet been determined can exclusively load the energy source 2.

In the embodiment, the complex impedance 35, which is assigned to the second electronic fuse 32 to be addressed, is closed for this purpose. All other complex impedances 34 and 36 are open. The complex impedances 34, 35 and 36 are structurally identical.

The second electronic fuse 32 to be addressed in the group then represents a short circuit in particular. Alternatively, it can also be provided that the bus line 3 is interrupted by the second fuse 31 to be addressed in that part of the bus line 3 which faces away from the electrical energy source 2, with the result that the bus line 3 has an open line end and is interrupted for subsequent electronic fuses 33.

The AC voltage is then changed by the control unit 4 to a second frequency, such that the first phase shift between the AC voltage and current determined for the first electronic fuse to be addressed is present. While the second frequency is present, the complex impedance 34, which is assigned to the first electronic fuse 31 to be addressed, is closed without change and the remaining complex impedances 35, 36 are open.

In order to be able to control the complex impedances 34, 35 and 36, each electronic fuse 31, 32, 33, and thus also each complex impedance 34, 35, 36, is already assigned a name before the start of the impedance measurement addressing. This name is not yet linked to a position in the electrical switching device 1. The name is also referred to as the ID. The name can already be assigned to the respective electronic fuse 31, 32, 33 during the production of the electronic fuse 31, 32, 33. This is the case in the embodiment. Each of the plurality of electronic fuses 31, 32, 33 is assigned a so-called UID (Unique Identifier). A UID is unique, and so there is almost no confusion. However, it is also possible for the electronic fuses 31, 32, 33 to generate a random name themselves before the start of the impedance measurement addressing. This can be a Universally Unique Identifier (UUID) or a Globally Unique Identifier (GUID). The probability of a UUID or a GUID being duplicated is so low that the probability of a collision is usually negligible. Before starting the impedance measurement addressing, the electronic fuses 31, 32, 33 must agree which of the electronic fuses 31, 32, 33 is the only one to first draw energy from the electrical energy source 2 via the bus line 3. Appropriate methods exist for this purpose in the prior art (arbitration or anti-collision methods which are used in multimaster systems or for reading out RFID tags).

Since the magnitude of the second frequency depends on the length of the line or on the second distance D2 between the control unit 4 and the electronic fuse 32 along the bus line 3, the control unit 4 can decide, on the basis of a comparison of the first frequency and the second frequency, whether the first electronic fuse 31 to be addressed or the second electronic fuse 32 to be addressed is further away from the control unit 4 along the bus line 3. That electronic fuse 31, 32 which is associated with the higher frequency is closer to the control unit 4. In the present example, the impedance measurement addressing was started with the electronic fuse 31 which is at a shorter first distance D1 from the control unit 4 than the electronic fuse 32, which is at the second distance D2 from the control unit 4. However, this order can also be the other way around. In the present example, the first frequency is greater than the second frequency because the second distance D2 is greater than the first distance D1.

After determining the first frequency and the second frequency, the control unit 4 can assign an address, via the bus line 3, at least to the first electronic fuse 31 to be addressed and to the second electronic fuse 32 to be addressed. In this case, that electronic fuse 31 which is associated with the higher frequency is linked to a position closer to the control unit 4 along the bus line 3.

In practice, during impedance measurement addressing, all electronic fuses 31, 32, 33 in the group are measured once before the actual address assignment in such a way that only a single electronic fuse 31, 32, 33 in the group of the plurality of electronic fuses 31, 32, 33 in each case draws energy from the electrical energy source 2 and none of the other electronic fuses 31, 32, 33 in the group. In other words, the phase shift or the frequency associated with the phase shift is measured for the connection of each individual complex impedance 34, 35, 36, while the remaining complex impedances 34, 35, 36 are open. The electronic fuses 31, 32, 33 can then be addressed. The following applies: The greater the frequency (“second frequency”) that had to be used for the AC voltage in order to produce the first phase shift between the AC voltage and current, the closer the electronic fuse 31, 32, 33 is to the control unit 4 along the bus line 3.

For the communication of the electronic fuses 31, 32, 33, each electronic fuse 31, 32, 33 is assigned a shift keying modem 47, 48, 49. The shift keying modem 47, 48, 49 can modulate a frequency onto the bus line 3. The shift keying modem 47, 48, 49 is arranged in a connecting line 44, 45, 46 between the electronic fuse 31, 32, 33 and the bus line 3. The above description of the shift keying modem 47, 48, 49 for the embodiment according to FIG. 3 also applies to the embodiment according to FIG. 4.

The control unit 4 also has a shift keying modem 50. Via the shift keying modem 50, the control unit 4 can send signals to the electronic fuses 31, 32, 33 via the bus line 3. Via the shift keying modem 47, 48, 49, the electronic fuses 31, 32, 33 can communicate their name to the control unit 4 before the impedance measurement addressing. Via the shift keying modem 50 of the control unit 4, the control unit 4 can assign its addresses to the electronic fuses 31, 32, 33 or can address the electronic fuses. In the embodiment, the shift keying modem 50 is a frequency shift keying modem. However, it can also be an amplitude or phase shift keying modem.

In the embodiment, only a relative arrangement of the electronic fuses 31, 32, 33 along the bus line 3 takes place. The address is only associated with the fact that a certain electronic fuse (for example, 33) is further away from the control unit 4 along the bus line 3 than another electronic fuse (for example 32).

In the embodiment, the first frequency of the AC voltage is selected in such a way that the first phase shift is approximately a multiple of 180°, in particular 180°. When setting the first frequency, the current intensity is measured at a zero crossing, in particular the first zero crossing, of the AC voltage. In particular, the frequency of the AC voltage is changed, starting from a frequency with a phase shift of less than 180° or less than 360°, such that the current intensity measured at the zero crossing of the AC voltage is approximately 0 A, in particular 0 A. In particular, the frequency of the AC voltage is increased, starting from 0 Hz, in particular starting from at least 1 Hz, in particular starting from at most 100 kHz, in particular starting from at most 1 MHz, until the current intensity measured at the first zero crossing of the AC voltage (that is, at It or at 180°) is approximately 0 A, in particular 0 A, for the first time. At the first frequency which is then present, the first phase shift is 180°.

In addition, in order to determine the second frequency, the frequency of the AC voltage is selected in such a way that the current intensity is approximately 0 A at a zero crossing, in particular the first zero crossing, of the AC voltage.

At a zero crossing of the AC voltage, the voltage is 0 V. At the first zero crossing of the AC voltage, the voltage changes its sign from positive to negative. The first zero crossing of the AC voltage takes place at 180° or at π.

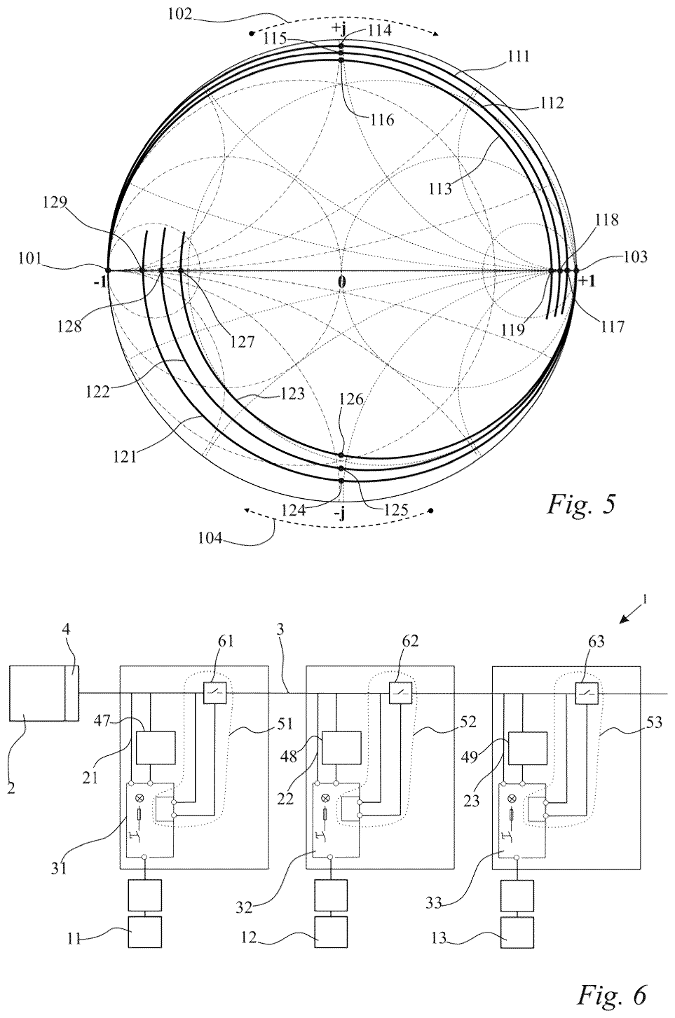

The first frequency and the second frequency are selected in the embodiment such that the first phase shift is approximately 180°, preferably 180°. In this case, the complex impedance of the entire system has only a real part. That this is the case can be shown particularly well via the Smith chart shown in FIG. 5.

The Smith chart is circular and is provided with a complex coordinate system. The impedance plane (z-plane) is mapped via conformal mapping to the reflection factor plane (r-plane) which forms the Smith chart within the unit circle. The mapping has the special property that the image of a number z in the impedance plane and that of its reciprocal value are point symmetrical around the origin in the reflection factor plane. The normalized value of the respective total complex impedance of the electrical switching device 1 can be represented in the Smith chart. This value depends on the frequency of the AC voltage. The position of the starting point in the Smith chart at a frequency of the AC voltage of 0 Hz depends on whether the electronic fuse to be addressed is closed or open. When the electronic fuse is closed, that is, when the line is short-circuited, the starting point 101 is at the position marked in FIG. 5 with the corresponding reference sign. Depending on the distance or spacing between the electronic fuse 31, 32, 33 and the control unit 4 along the bus line 3, the complex total impedance follows one of the curves 111, 112, 113. The curve 111 is assigned to the first electronic fuse 31 which is at the first distance D1 from the control unit 4. The second curve 112 is assigned to the second electronic fuse 32 which is at the second distance D2 from the control unit 4. The third curve 113 is assigned to the third electronic fuse 33 which is at the third distance D3 from the control unit 4.

At the measuring point 114, 115, 116 located along the curve 111, 112, 113, the phase shift between the voltage and current is 90°. The real part and the imaginary part of the complex total impedance are of the same magnitude. The measuring points 114, 115, 116 differ in that they are reached at different frequencies for the AC voltage. At the measuring point 114, which is assigned to the curve 111, the frequency of the AC voltage is greater than at the measuring point 115 which is assigned to the curve 112. At the measuring point 115, the frequency of the AC voltage is greater than at the measuring point 116 which is assigned to the curve 113. A phase shift between the applied AC voltage and measured current of 180° is achieved at the measuring point 117, 118, 119. The measuring point 117 is assigned to the curve 111, the measuring point 118 is assigned to the curve 112 and the measuring point 119 is assigned to the curve 113. The measuring point 117 is assigned to the electronic fuse 31, the measuring point 118 is assigned to the electronic fuse 32 and the measuring point 119 is assigned to the electronic fuse 33. The measuring point 117 is assigned to the electronic fuse 31 at the shortest, first distance D1 from the control unit 4. The measuring point 118 is assigned to the electronic fuse 32 at the middle, second distance D2 from the control unit 4. The measuring point 119 is assigned to the electronic fuse 33 at the largest, third distance D3 from the control unit 4. At the measuring point 117, 118, 119, the complex total impedance has only a real part. The imaginary part is zero. The measuring points 117, 118, 119 differ in that they are reached at different frequencies for the AC voltage. If the electrical energy source 2 is loaded only by the first electronic fuse 31, a phase shift of 180° at the measuring point 117 is only achieved at a higher frequency for the AC voltage than when the electrical energy source 2 is loaded only by the second electronic fuse 32, and the measuring point 118 is reached with a phase shift of 180° at a lower frequency for the AC voltage. In a similar manner, the measuring point 119 is associated with the lowest frequency for the AC voltage compared to the measuring points 117 and 118. Since the complex total impedance at the measuring points 117, 118 and 119 has only a real part and no imaginary part, these measuring points are preferred.

Due to the then missing imaginary part of the complex total impedance, a phase shift corresponding to a multiple of 180° is preferred. The first and the second frequency are accordingly selected such that the (first) phase shift is a multiple of approximately 180°, in particular a multiple of 180°, in particular approximately 180°, in particular 180°. In the embodiment, the first and the second frequency therefore correspond to a phase shift of 180° between the voltage and current. It may also be provided that the first and second frequencies are selected in such a way that the phase shift corresponds to a multiple of 90°. Accordingly, the first and the second frequency can be selected in such a way that the phase shift is 90° (or 270° or −90°). The current then has an extreme value at a zero crossing of the voltage. For a phase shift of 90°, the real part of the complex total impedance is zero and the complex total impedance has only an imaginary part.

When the electronic fuse to be addressed is closed, the curve 111, 112, 113 runs, with an increasing frequency of the AC voltage starting from the starting point 101, in the direction 102. The direction 102 is clockwise. The curve 111, 112, 113 runs along the edge of the Smith chart. The frequency at the measuring point 114, 115, 116 is half the frequency at the measuring point 117, 118, 119. The frequency behaves linearly along the curve 111, 112, 113. If the distance traveled along the curve 111, 112, 113 is twice as large, the frequency of the AC voltage is also twice as large. This applies in each case to one of the curves 111, 112, 113 taken individually.

If the bus line 2 is open, that is, there is an open line end, immediately downstream of the electronic fuse 31, 32, 33 to be addressed or that electronic fuse 31, 32, 33 whose relative distance is intended to be determined, the starting point 103 is at the position marked in FIG. 5 with 103. At the starting point, there will then be a phase shift of 0° between the AC voltage and current for an AC voltage with a frequency of 0 Hz. The total complex impedance corresponds to the insulation resistance of the line. In a similar manner to that described above for the case of the closed fuse, the complex total impedance follows a curve 121, 122, 123 when the AC voltage is increased. The curve 121 is assigned to the electronic fuse 31. The curve 122 is assigned to the electronic fuse 32. The curve 123 is assigned to the electronic fuse 33. The course of the curve 121, 122, 123 is linked in each case to the prerequisites described above. The electronic fuse 31, 32, 33 assigned to the curve 121, 122, 123 in each case loads the electrical energy source 2 exclusively. As the frequency of the AC voltage increases, the curve 121, 122, 123 follows the direction 104 starting from the starting point 103. The direction 104 is clockwise. The curve 121, 122, 123 has a measuring point 124, 125, 126. The measuring point 124 is assigned to the curve 121, the measuring point 125 is assigned to the curve 122 and the measuring point 126 is assigned to the curve 123. At the measuring point 124, 125, 126, the phase shift between the voltage and the current is 90°. At the measuring point 124, the frequency of the voltage is greater than at the measuring point 125. At the measuring point 125, the frequency of the voltage is greater than at the measuring point 126. At the measuring point 124, 125, 126, the complex total impedance has only an imaginary part of the same magnitude.

The curve 121, 122, 123 has a measuring point 127, 128, 129. The measuring point 127 is assigned to the curve 121, the measuring point 128 is assigned to the curve 122 and the measuring point 129 is assigned to the curve 123. At the measuring point 127, 128, 129, the phase shift between the frequency of the AC voltage and the current is 180°. At the measuring point 127, 128, 129, the complex total impedance has only a real part and no imaginary part. At the measuring point 127, the frequency of the AC voltage is greater than at the measuring point 128. At the measuring point 128, the frequency of the AC voltage is greater than at the measuring point 129. Along the curve 121, 122, 123, the frequency of the electrical voltage increases proportionally as the curve length increases.

At the measuring points 117, 118, 119, 127, 128, 129, measurements can be carried out particularly well because the phase angle of the measurement signals and thus the zero crossings are shifted by 180°.

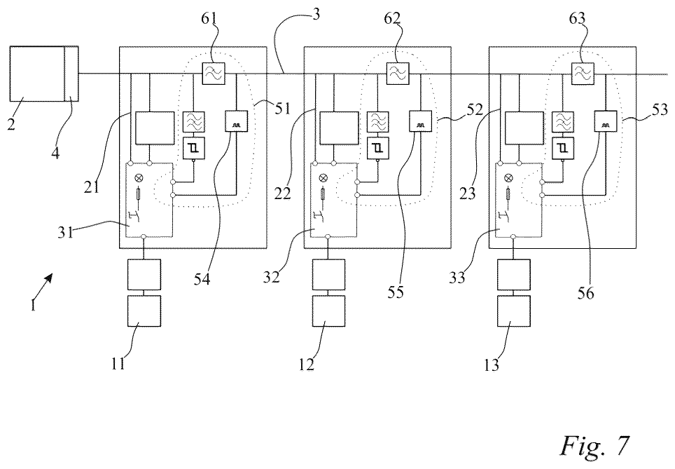

FIGS. 6 and 7 show alternative configurations of a detail of the switching device 1 from FIG. 1. Again, only the fuses 31, 32 and 33 are shown by way of example in FIGS. 6 and 7. The configuration of the switching device 1 in the area between the electronic fuses 31, 32, 33 and the bus line 3 can, however, also be made in the other electronic fuses 31a, 31b. The addressing via the devices shown in FIG. 6 or 7 is also referred to as chain addressing. FIGS. 6 and 7 each show alternative configurations for chain addressing. Unless explicitly mentioned, the following description applies to both FIG. 6 and FIG. 7.

Each of the plurality of electronic fuses 31, 32, 33 is assigned an addressing apparatus 51, 52, 53. The addressing apparatus 51 is assigned to the electronic fuse 31, the addressing apparatus 52 is assigned to the electronic fuse 32 and the addressing apparatus 53 is assigned to the electronic fuse 33. When addressing the plurality of electronic fuses 31, 32, 33 in the group via chain addressing, one addressing signal each runs through at least one part of the bus line 3 for addressing each of the plurality of electronic fuses 31, 32, 33. Each addressing apparatus 51, 52, 53 can prevent the addressing signal from being passed to the directly adjacent electronic fuse 32, 33 in the group along the bus line 3. For example, the first addressing apparatus 51 can prevent an addressing signal from being conducted to the second electronic fuse 32. The electrical switching device is configured in such a way that the addressing apparatus 51, 52, 53 of an electronic fuse 31, 32, 33 in the group, which has received an addressing signal, then causes the electronic fuse 32, 33 in the group that is directly adjacent along the bus line 3 in the direction away from the control unit 4 to then be addressed.

In the embodiments according to FIGS. 6 and 7, when addressing the plurality of electronic fuses 31, 32, 33, the control unit 4 first emits an addressing signal for addressing the electronic fuse 31 which is closest to the control unit 4 along the bus line 3. At this time, all addressing apparatuses 51, 52, 53 are set such that they prevent the addressing signal from being conducted to the directly adjacent electronic fuse 32, 33 in the group along the bus line 3. Therefore, the addressing signal emitted by the control unit 4 can only reach the first electronic fuse 31 and address it. The first electronic fuse 31 then causes the first addressing apparatus associated with it to be set such that it allows a further addressing signal to be conducted, via the bus line 3, to the electronic fuse 32 directly adjacent to the first electronic fuse 31 along the bus line 3. It may be provided that the first electronic fuse 31 sends a signal to the control unit 4 after it has been addressed via the shift keying modem 47 assigned to it, which signal causes the control unit 4 to emit a further addressing signal for addressing the electronic fuse 32 located closest to the control unit 4 along the bus line 3 after the electronic fuse addressed last.

In the embodiment according to FIG. 6, the control unit 4 emits all addressing signals. In the embodiment according to FIG. 7, the control unit 4 emits only the first addressing signal for addressing the first electronic fuse 31 which is closest to the control unit 4 along the bus line 3. After the first electronic fuse 31 has been addressed, the electronic fuse 31 generates an addressing signal via a signal generator shown in FIG. 7, which signal causes the directly adjacent electronic fuse 32 along the bus line 3 to be addressed.

All addressing apparatuses 51, 52, 53 have a damping apparatus 61, 62, 63. The damping apparatus 61 is assigned to the electronic fuse 31, the damping apparatus 62 is assigned to the electronic fuse 32 and the damping apparatus 63 is assigned to the electronic fuse 33. The damping apparatus 61, 62, 63 of a specific electronic fuse 31, 32, 33 in the group can be used to prevent the addressing signal from being conducted to that electronic fuse 32, 33 in the group which is directly adjacent to the specific electronic fuse 31 along the bus line 3. When addressing the plurality of electronic fuses 31, 32, 33 in the group via the bus line 3, all damping apparatuses 61, 62, 63 initially act in such a way that an addressing signal is prevented from being conducted in the bus line 3 between two electronic fuses 31, 32, 33 in the group that are directly adjacent along the bus line 3. In the embodiment according to FIGS. 6 and 7, the damping apparatus 61, 62, 63 is arranged in the bus line 3. At the beginning of chain addressing, the control unit 4 emits, via the bus line 3, a first addressing signal which passes, without being disturbed by the damping apparatuses 61, 62, 63, to the electronic fuse 31 that is closest to the control unit 4 along the bus line 3. This electronic fuse 31 is assigned an address via the addressing signal. The corresponding address is linked to the position closest to the control unit 4 along the bus line 3. The damping apparatus 51 belonging to the electronic fuse 31 addressed in this manner prevents the first addressing signal from being conducted to the electronic fuse 32, 33 located directly adjacent to the electronic fuse 31 to be addressed first along the bus line 3.

In the embodiment according to FIG. 6, the damping apparatus 61, 62, 63 is a switchable switch. In the embodiment, the damping apparatus 61, 62, 63 in FIG. 6 is a field effect transistor, in particular a MOSFET. This damping apparatus 61, 62, 63 can be switched by the electronic fuse 31, 32, 33. In the embodiment, the damping apparatus 61, 62, 63 or the switch formed by the damping apparatus 61, 62, 63 is open in a de-energized form. When the first addressing signal is emitted, the addressing signal can only reach the first electronic fuse 31. The first damping apparatus 61, as an open switch arranged in the bus line 3, prevents the first addressing signal from being able to reach the second electronic fuse 32. The first damping apparatus 61 is arranged in the bus line 3 between the first electronic fuse 31 and the second electronic fuse 32. In a similar manner, the second damping apparatus 62 is arranged in the bus line 3 between the second electronic fuse 32 and the third electronic fuse 33. The first damping apparatus 61, in particular the MOSFET, can be closed by an electrical signal emitted by the corresponding electronic fuse 31, 32, 33. After addressing the first electronic fuse 31, the first damping apparatus 61 is switched off in this manner. The switch is then closed. A second addressing signal emitted by the control unit 4 can then reach the second electronic fuse 32 in the bus line 3 and can address this second electronic fuse 32. The second damping apparatus 62 is then switched off by closing the switch.

As shown in FIG. 7, the damping apparatus 61, 62, however, can also be configured as a pass filter, in particular as a low-pass filter. The high-frequency addressing signals cannot pass through this pass filter. The energy line in the bus line is not affected by this. After addressing the first electronic fuse 31, which is closest to the control unit 4 along the bus line 3, via an addressing signal emitted by the control unit 4, the first electronic fuse 31 in the embodiment according to FIG. 7 generates, via the first signal generator 54, a second addressing signal for addressing the second electronic fuse 32 which is closest to the control unit 4 along the bus line 3 after the first electronic fuse 31 addressed last. The second addressing signal is fed to the bus line 3 between the first damping apparatus 61 and the second electronic fuse 32. Thus, the second addressing signal is unaffected by the first damping apparatus 61. These method steps are repeated in a similar manner for the subsequent electronic fuses 32 and 33. In this way, the plurality of electronic fuses 31, 32, 33 in the group are addressed successively, in a chain-like manner. The electronic fuse 31, 32, 33 addressed last respectively causes the directly adjacent electronic fuse 32, 33 to be addressed.

Formulated in a general form for both embodiments according to FIGS. 6 and 7, an electronic fuse 31, 32, 33, after it has been assigned an address, initiates:
the damping apparatus 61, 62, 63 associated with it being switched off and a further addressing signal being emitted by the control unit 4, or
a further addressing signal being generated by the addressing apparatus 51, 52, 53 belonging to the electronic fuse 31, 32, 33 addressed last and this further addressing signal being passed to the bus line 3, with respect to the control unit 4, downstream of the damping apparatus 51, 52, 53 belonging to the electronic fuse 31, 32, 33 addressed last.

This further addressing signal is used to address that electronic fuse 32, 33 in the group which is directly adjacent to the electronic fuse 31, 32, 33 addressed last along the bus line. The further addressing signal is used to assign an address, via the bus line 3, to the electronic fuse 32, 33 directly adjacent to the electronic fuse 31, 32, 33 addressed last along the bus line 3 in the direction away from the control unit 4, the address being linked to the position located closest to the electronic fuse 31, 32 addressed last along the bus line 3 in the direction away from the control unit 4. The addressing of the group of the plurality of electronic fuses 31, 32, 33 is continued successively until all of the plurality of electronic fuses 31, 32, 33 in the group have been addressed.

In the embodiment according to FIG. 7, communication between the control unit 4 and the electronic modules 31, 32, 33 is still possible by modulating a signal with a low frequency. The damping apparatuses 61, 62, 63 configured as low-pass filters only prevent high-frequency signals from being conducted through bus line 3. The addressing signals are accordingly such high-frequency signals. The frequency band of the bus line or the bus line used as the communication line is divided into a high-frequency range and a low-frequency range.

It is understood that the foregoing description is that of the preferred embodiments of the invention and that various changes and modifications may be made thereto without departing from the spirit and scope of the invention as defined in the appended claims.

1. An electrical switching device comprising:
a plurality of electrical loads;
an electrical energy source for supplying electrical energy to said plurality of electrical loads;
a bus line for conducting said electrical energy from said electrical energy source to said plurality of electrical loads;
said plurality of electrical loads being connected to said bus line;
a group of a plurality of electronic fuses electrically arranged between said electrical energy source and said plurality of electrical loads;
said plurality of electronic fuses being separate from each other and being distributed in said electrical switching device; and,
a control unit being arranged in said bus line and being configured to address said plurality of electronic fuses in said group via said bus line.

2. The electrical switching device of claim 1, wherein, when addressing said group of said plurality of electronic fuses, a position of the electronic fuse to be addressed from the group relative to the other electronic fuses from said group in said electrical switching device is determined and then an address is assigned to said electronic fuse to be addressed.

3. The electrical switching device of claim 2, wherein said address is assigned by said control unit.

4. The electrical switching device of claim 1, wherein said electrical switching device further comprises: a plurality of current measuring apparatuses, each of said plurality of electronic fuses is assigned a corresponding one of said current measuring apparatuses with a load resistor, at least part of the group of the plurality of electronic fuses belongs to an initial load group;
said initial load group includes: that electronic fuse in said group of said plurality of electronic fuses which is arranged furthest away from said electrical energy source along said bus line and at least one further electronic fuse in said group of said plurality of electronic fuses; and,
said control unit is configured such that, when addressing the plurality of electronic fuses in said group, all load resistors in said initial load group are first connected to said bus line and load said electrical energy source, said current measuring apparatuses assigned to said electronic fuses in said initial load group measure the current in said bus line downstream of the respectively associated electronic fuse, and said control unit assigns an address, via said bus line, to that electronic fuse in the initial load group which is associated with a current measured value below an open-circuit current value of said electrical switching device, said address being linked to the position furthest away from said electrical energy source along said bus line.

5. The electrical switching device of claim 4, wherein, when addressing said group of said plurality of electronic fuses after an address has been assigned to an electronic fuse, the associated load resistor is disconnected from said bus line and remains disconnected during further addressing, when further addressing said group of said plurality of electronic fuses, said electrical energy source is loaded by said load resistors in said initial load group that are still connected to said bus line, said current measuring apparatuses assigned to the electronic fuses in said initial load group measure the current in said bus line downstream of the respectively associated electronic fuse, and said control unit assigns an address, via said bus line, to that electronic fuse of the electronic fuses in said initial load group with load resistors still connected to said bus line which is associated with a current measured value below an open-circuit current value of said electrical switching device, said address being linked to that position of the electronic fuses in the initial load group with load resistors still connected to said bus line which is furthest away from said electrical energy source along said bus line.

6. The electrical switching device of claim 5, wherein the addressing takes place until all load resistors in the initial load group are disconnected from said bus line.

7. The electrical switching device of claim 4, wherein the electronic fuse from the initial load group, the load resistor thereof being connected to said bus line and which is associated with a current measured value below an open-circuit current value of said electrical switching device, sends a signal for requesting an address to said control unit.

8. The electrical switching device of claim 1, wherein said electrical switching device is configured in such a way that, when addressing said plurality of electronic fuses in the group, apart from a first electronic fuse to be addressed in the group, none of the electronic fuses in the group initially load said electrical energy source via said bus line, an AC voltage having a first frequency specified by said control unit is applied to said bus line, said control unit determines a first phase shift between the current and voltage, and the distance between the first electronic fuse to be addressed and said control unit is determined on the basis of the first phase shift.

9. The electrical switching device of claim 8, wherein, after the first phase shift has been determined, apart from a second electronic fuse to be addressed in the group of the plurality of electronic fuses, none of the electronic fuses in the group load said electrical energy source via said bus line; and,
an AC voltage is applied by said control unit at a second frequency, the second frequency being selected such that the first phase shift between the current and voltage determined for the first electronic fuse to be addressed is present, and said control unit decides, on the basis of a comparison of said first frequency and said second frequency, whether the first electronic fuse to be addressed or the second electronic fuse to be addressed is further away from said control unit along said bus line.

10. The electrical switching device of claim 9, wherein, after determining said second frequency, said control unit assigns an address, via said bus line, at least to the first electronic fuse to be addressed and to the second electronic fuse to be addressed, that electronic fuse which is associated with the higher frequency being linked to a position closer to said control unit along said bus line.

11. The electrical switching device of claim 9, wherein said first frequency is selected in such a way that the first phase shift is a multiple of 90°.

12. The electrical switching device of claim 11, wherein, in order to select the first frequency such that the first phase shift is a multiple of 180°, the current intensity is measured at a zero crossing of the AC voltage, and the frequency of the AC voltage is changed, starting from a frequency with a phase shift of less than 180° or less than 360°, such that the current intensity is approximately zero.

13. The electrical switching device of claim 1, wherein each of the plurality of electronic fuses is assigned an addressing apparatus, when addressing said plurality of electronic fuses in the group, one addressing signal each runs through at least one part of said bus line for addressing each electronic fuse, each addressing apparatus can prevent the addressing signal from being conducted to the directly adjacent electronic fuse in the group along said bus line, said electrical switching device is configured in such a way that the addressing apparatus of an electronic fuse in the group which has received an address then causes the directly adjacent electronic fuse in the group along said bus line to be addressed.

14. The electrical switching device of claim 13, wherein all addressing apparatuses have a damping apparatus, the damping apparatus of a specific electronic fuse in the group can prevent the addressing signal from being conducted to that electronic fuse in the group which is directly adjacent to the specific electronic fuse along said bus line, when addressing the plurality of electronic fuses in the group via said bus line, all damping apparatuses initially act in such a way that an addressing signal is prevented from being conducted in said bus line between two electronic fuses in the group that are directly adjacent along said bus line, said control unit then emits, via said bus line, a first addressing signal which passes, without being disturbed by said damping apparatuses, to the electronic fuse that is closest to said control unit along said bus line and assigns an address thereto, said address being linked to the position closest to said control unit along said bus line, and the damping apparatus belonging to the addressed electronic fuse prevents the first addressing signal from being conducted to the electronic fuse located directly adjacent to the addressed electronic fuse along said bus line.

15. The electrical switching device of claim 14, wherein, when addressing said plurality of electronic fuses in the group, after an address has been assigned to an electronic fuse, this electronic fuse initiates:
i) the damping apparatus associated therewith being switched off and a further addressing signal being emitted by said control unit, or
ii) a further addressing signal being generated by the addressing apparatus belonging to the electronic fuse addressed last and this further addressing signal being passed to said bus line, with respect to said control unit, downstream of the damping apparatus belonging to the electronic fuse addressed last for addressing that electronic fuse in the group which is directly adjacent to the electronic fuse addressed last along said bus line; and,
the further addressing signal is used to assign an address, via said bus line, to the electronic fuse directly adjacent to the electronic fuse addressed last along said bus line, said address being linked to the position located closest to the electronic fuse addressed last along said bus line.

16. The electrical switching device of claim 15, wherein the addressing of the group of the plurality of electronic fuses is continued successively until all of the plurality of electronic fuses in the group have been addressed.

17. The electrical switching device of claim 1, wherein said plurality of electrical loads are each connected to said bus line via stub lines, and the electronic fuses in said group of a plurality of electronic fuses are arranged in said stub lines.

18. The electrical switching device of claim 4, wherein the initial load group includes all other electronic fuses in said group of said plurality of electronic fuses.

19. The electrical switching device of claim 1, wherein said control unit is configured in such a way that, when addressing the plurality of electronic fuses in said group, apart from a first electronic fuse to be addressed in the group, none of the electronic fuses in the group initially load said electrical energy source via said bus line, an AC voltage at a first frequency specified by said control unit is applied to said bus line by said control unit, said control unit determines a first phase shift between the current and voltage, and the distance between the first electronic fuse to be addressed and said control unit is determined in relation to the other electronic fuses in the group on the basis of the first phase shift, and that the first frequency is selected in such a way that the first phase shift is ≤360°.

20. The electrical switching device of claim 9, wherein the first frequency is selected in such a way that the first phase shift is a multiple of 180°, in order to select the first frequency such that the first phase shift is a multiple of 180°, the current intensity is measured at a zero crossing of the AC voltage, the frequency of the AC voltage is changed, starting from a frequency with a phase shift of less than 180° or less than 360°, such that the current intensity is approximately zero, and, in order to determine the second frequency, the frequency of the AC voltage is selected such that the current intensity is approximately zero at a zero crossing of the AC voltage.

21. The electrical switching device of claim 13, wherein all addressing apparatuses have a damping apparatus, the damping apparatus of a specific electronic fuse in the group can prevent the addressing signal from being conducted to that electronic fuse in the group which is directly adjacent to the specific electronic fuse along said bus line, when addressing said plurality of electronic fuses in the group via said bus line, all damping apparatuses in said bus line initially act in such a way that an addressing signal is prevented from being conducted in said bus line between two electronic fuses in said group that are directly adjacent along said bus line, said control unit then emits, via said bus line, a first addressing signal which passes, without being disturbed by said damping apparatuses, to the electronic fuse that is closest to said control unit along said bus line and assigns an address thereto, said address being linked to the position closest to said control unit along said bus line, and the damping apparatus belonging to the addressed electronic fuse prevents the first addressing signal from being conducted to the electronic fuse located directly adjacent to the addressed electronic fuse along said bus line.
